(19) United States
(12) Patent Application Publication
(10) Pub. No.: US 2009/0301211 A1
(43) Pub. Date: Dec. 10, 2009

(54) CAPACITANCE TYPE PRESSURE SENSOR

(75) Inventors: Yasuhide Yoshikawa, Tokyo (JP); Jun Ichihara, Tokyo (JP)

Correspondence Address: DARBY & DARBY P.C., P.O. BOX 770, Church Street Station, New York, NY, 10008-0770, US

(73) Assignee: YAMATAKE CORPORATION, TOKYO (JP)

(21) Appl. No.: 12/306,686

(22) PCT Filed: Jun. 11, 2007
(86) PCT No.: PCT/JP2007/061732

§ 371 Date: Jul. 16, 2009

(30) Foreign Application Priority Data
Jun. 27, 2006 (JP) 2006-177359

(51) Int. Cl. G01L 9/12

(52) U.S. Cl. 73/724

(57) ABSTRACT

A capacitance-type pressure sensor for measuring a change in a physical volume of a medium to be measured, by measuring two capacitances wherein the capacitances vary differently from each other in accordance with a change in the physical volume of the medium to be measured, provided with a function for measuring independent values for each capacitance and determining that there is an disconnect failure when at least one of these capacitance values falls below a capacitance value that indicates the normal operating range of the capacitance-type pressure sensor, to thereby provide a pressure sensor with higher reliability through performing the disconnect detection robustly.

### CROSS REFERENCE TO RELATED APPLICATIONS

This is a U.S. national phase application under 35 U.S.C. § 371 of International Patent Application No. PCT/JP2007/061732, filed Jun. 11, 2007 and claims the benefit of Japanese Application 2006-177359 filed Jun. 27, 2006. The International Application was published on Jan. 3, 2008 as International Publication No. WO 2008/001602 under PCT Article 21(2) the contents of which are incorporated herein in their entirety.

### FIELD OF TECHNOLOGY

The present invention relates to a capacitance-type pressure sensor used in measuring absolute pressures, gauge pressures, and differential pressures.

### BACKGROUND

In semiconductor chip manufacturing processing, for example, pressure sensors that are structured with a capacitance detecting portion within a capacitance chamber, with one portion made from a diaphragm, are used broadly. (See, Japanese Unexamined Patent Application Publication 2002-111011 (“JP'011”, Pages 4-7 and FIG. 1)

This type of vacuum pressure sensor that measures the pressure in vacuum equipment in fields such as a semiconductor chip manufacturing processing is provided in a vacuum chamber, and, as elements thereof, is provided with, for example, a gauge pressure sensor for checking whether or not a gauge pressure has been achieved within a vacuum chamber when a silicon wafer or a semiconductor chip, as a product, has been loaded, and a vacuum sensor for measuring the pressure of the process gases that flow into the vacuum chamber in essentially a vacuum, during a process such as CVD (chemical vapor deposition).

Note that typically this type of vacuum pressure sensor is not only provided with a pressure sensitive capacitance detecting portion that has a broad range of sensitivity to the pressure of the sensor diaphragm, but is also provided with a reference capacitance detecting portion that has a small range of sensitivity in regards to pressure, where the reference capacitance detecting portion is used only for compensating for the drift in the output of the pressure sensitive capacitance detecting portion due to variations in the ambient temperature, for example, of the pressure sensor.

Patent Reference 1: Japanese Unexamined Patent Application Publication 2002-111011 (Pages 4-7 and FIG. 1)

The pressure sensor disclosed in Japanese Unexamined Patent Application Publication 2005-331328 (“JP '328”) is proposed as an example of increasing further the detection accuracy of the pressure-type sensor disclosed in JP'011. As shown in FIG. 1 in JP'328, the pressure sensor is provided with a base portion, made out of sapphire, which is single crystal aluminum oxide (Al₂O₃), a diaphragm made out of the same sapphire, and a pressure sensitive electrode and reference electrode that are disposed facing each other in the capacitance chamber made on the base portion and the diaphragm. A recessed portion is formed in the base portion through dry etching, wherein the pressure sensitive capacitance detecting electrode, which is around, for example, in the plan view, is formed from gold (Au) or platinum (Pt) in essentially the center of the indented portion. The reference volume detecting electrode, which is annular, for example, in the plan view, is formed separate from this electrode, so as to encompass this electrode. Furthermore, these electrodes that are formed on the diaphragm and the base portion are connected electrically to the outside of the sensor through the respective lead lines and electrode pads.

In capacitance-type pressure sensors, including the types described above, sometimes the conductor patterns that connect between the electrodes on the diaphragms and the pads become disconnects.

While the field of technology is different from that of pressure sensors, there is, as a method for detecting disconnects of this type, the method of detecting disconnects in acceleration sensors described in, for example, Japanese Unexamined Patent Application Publication H5-281256.

A block structural diagram of this capacitance-type acceleration sensor 6 is illustrated in FIG. 10. The capacitance-type acceleration sensor 6 comprises a diagnostic controlling circuit 61, an electrostatic capacitance detecting signal generating circuit 62, switches 63 and 64, electrostatic capacitors 65 and 66, resistors 67 and 68, a voltage step up circuit 69, a detecting portion 70, an electrostatic capacitance detector 75, an output adjusting circuit 76, and switches 77 and 78, where the disconnect detecting function is added to the circuitry that measures the acceleration.

The disconnect detection that is disclosed in this capacitance-type acceleration sensor 6 is controlled by the diagnostic controlling circuit 61 to start with the falling edge of a signal Φ MR after the conclusion of a leakage current detection diagnostic. Specifically, a signal Φ F goes to the HIGH level at the start of the disconnect detection diagnostic, square wave signals V_{C1} and V_{C2}, which are applied to stationary electrodes, are caused to be in phase with each other, and a voltage Vo, which is proportional to the sum of the capacitances CX and CY between a movable electrode 613 and the stationary electrodes 611 and 612, is outputted from an electrostatic capacitance detector 75. This output voltage Vo is compared with a reference voltage by the diagnostic controlling circuit 61, and if this output voltage Vo exceeds a predetermined range, that is, if the sum of the capacitance CX and the capacitance CY deviates from the specification value, then a signal Φ OFF is held at a LOW level while the diagnostic signal is at the LOW level. By maintaining this output at the predetermined voltage, the system that uses the acceleration sensor is notified that the acceleration sensor has an disconnect fault.

However, in the disconnect detection by this capacitance-type acceleration sensor 6, the disconnect fault is detected only when the sum of the capacitance CX and the capacitance CY between the movable electrode 613 and the stationary electrodes 611 and 612 falls below the specification value, and so it is not possible to detect an disconnect in the interconnections when the sum of the capacitance CX and the capacitance CY is within the normal range, which is the result when, for example, either the capacitance CX or the capacitance CY greatly exceeds the specification value when the interconnection for the other capacitance is an disconnect.

There is also a problem in the disconnect detection in the capacitance-type acceleration sensor 6 in that it is necessary to incorporate a special routine for the disconnect detection period into the normal acceleration measurement routine in order to output, to the electrostatic capacitance detector 75, the voltage Vo that is proportional to the sum of the capacitance CX and the capacitance CY between the movable electrode and the stationary electrodes, by specially causing the square waveforms V_{C1} and V_{C2}, which are applied to the stationary electrodes, to be in phase with each other.

The object of the present invention is to provide a capacitance-type pressure sensor with higher reliability through performing the disconnect detection reliably.

### THE SUMMARY OF THE INVENTION

In order to solve the problems set forth above, the pressure sensor according to the present invention is a capacitance-type pressure sensor for measuring changes in the physical volume of a medium that is measured, doing so by measuring two capacitances wherein the relative relationships between the capacitances will vary in accordance with the change of the physical volume of the medium to be measured, wherein:

a function is provided to measure each of the individual capacitance values independently, and to determine that there is an disconnect fault when at least one of the individual capacitance values is less than a capacitance value indicated by a normal operating range for the capacitance-type pressure sensor.

A capacitance-type pressure sensor having this type of structure enables the reliable detection of an disconnect in the electrode lead conductor portions that are connected between the pads and the electrodes that are formed on the diaphragm.

A capacitance-type pressure sensor as set forth in the present invention is the capacitance-type pressure sensor set forth above, wherein:

one of the two capacitances is a pressure sensitive capacitance, and the other is a reference capacitance.

Even in the case of a capacitance-type pressure sensor having this structure, it is possible to detect an disconnect in the electrode lead conductor portion and in the electrodes that are formed on the diaphragm.

In addition, the capacitance-type pressure sensor of according to the present invention is the capacitance-type pressure sensor set forth above, wherein:

the two individual capacitances output differently from each other in accordance with a change in the physical volume of the medium to be measured.

Even in the case of a capacitance-type pressure sensor having this structure, it is possible to detect an disconnect in the electrode lead conductor portion and in the electrodes that are formed on the diaphragm.

In addition, the capacitance-type pressure sensor as set forth in the present invention is the capacitance-type pressure sensor as set forth above, wherein:

the capacitance-type pressure sensor is not only provided with a base portion and a diaphragm made out of a semiconductor, and an electrode for detecting a reference capacitance and an electrode for detecting a pressure sensitive capacitance, disposed facing each other in a capacitance chamber formed on the base portion and the diaphragm, but also the individual electrodes that are formed on the base portion and the diaphragm are connected electrically to outside of the sensor through the respective lead lines and electrode pads.

Furthermore, the capacitance-type pressure sensor according to the present invention, wherein:

the capacitance-type pressure sensor is provided with a base portion that is made out of a semiconductor that is formed in a thick ring shape, having a protruding portion facing towards the inside around the entire periphery in essentially the center portion of the inner peripheral surface, diaphragms, made from semiconductor, that are formed so as to cover, respectively, two opening portions of the base portion, having the center portions thereof connected together by a connecting portion, a first electrode that is formed so as to face the protruding portion of the base portion and one of the diaphragms, and a second electrode that is formed so as to face the protruding portion of the base portion and the other of the diaphragms, such that not only does the first electrode detect the capacitance of one of the two capacitances, but the second electrode detects the capacitance of the other of the two capacitances, and also the individual electrodes that are formed on the base portion and the diaphragm are connected electrically to outside of the sensor through the respective lead lines and electrode pads.

### BRIEF DESCRIPTION OF THE DRAWINGS

FIG. 1 is a cross-sectional diagram illustrating the schematic structure of a capacitance-type pressure sensor as set forth in an embodiment according to the present invention, with the cross-sectional hatching omitted;

FIG. 2 is a cross-sectional diagram illustrating the schematic structure of a differential capacitance-type pressure sensor as set forth in another embodiment according to the present invention, with the cross-sectional hatching omitted;

FIG. 3 is a first circuit structure diagram of a capacitance-type pressure sensor as set forth in two embodiments according to the present invention;

FIG. 4 is a table showing the output values obtained in time divisions through the circuit structure diagram of FIG. 3;

FIG. 5 is a second circuit structure diagram of a capacitance-type pressure sensor as set forth in the embodiments according to the present invention;

FIG. 6 is a flowchart of a first algorithm showing an disconnect detecting routine for the capacitance-type pressure sensor as set forth in the first example of embodiment and the second example of embodiment according to the present invention;

FIG. 7 is a flowchart for a second algorithm that is a modified example of the disconnect detecting routine of FIG. 6;

FIG. 8 is a table showing an example of disconnect detection in the conventional capacitance-type acceleration sensor and the disconnect detection in the absolute pressure capacitance-type pressure sensor as set forth in the first example of embodiment according to the present invention;

FIG. 9 is a table showing an example of disconnect detection in the conventional capacitance-type acceleration sensor and the differential pressure-type capacitance-type pressure sensor as set forth in the second example of embodiment according to the present invention; and

FIG. 10 is a diagram illustrating the schematic structure of a conventional acceleration sensor.

### DETAILED DESCRIPTION OF THE INVENTION

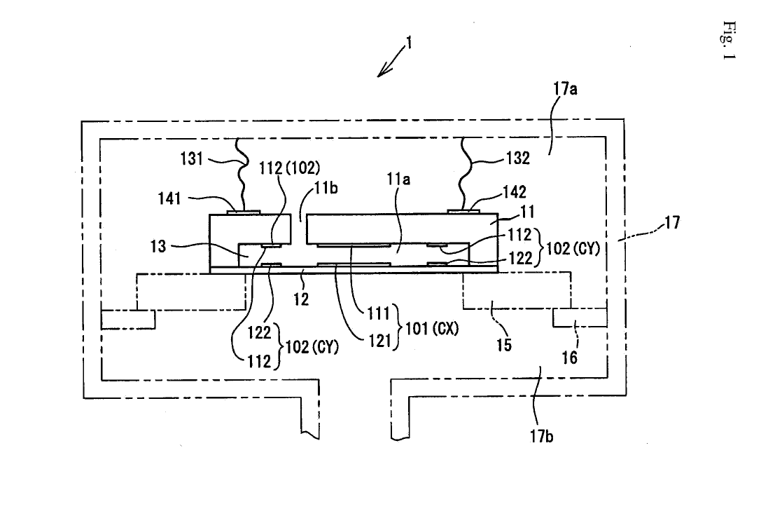

A capacitance-type pressure sensor 1 as set forth in an embodiment according to the present invention will be described below based on the drawings. The capacitance-type pressure sensor 1 according to the present invention is a capacitance-type pressure sensor for measuring the absolute pressure of an object to be measured, such as a vacuum pressure sensor, and, as illustrated in FIG. 1, is provided with a base portion 11 made out of sapphire, which is a single crystal aluminum oxide (Al₂O₃), a diaphragm 12 made out of the same sapphire, and pressure sensitive capacitance detecting electrodes 111 and 121 and reference capacitance detecting electrodes 112 and 122, which are disposed facing each other in a capacitance chamber 13, formed on the base portion 11 and the diaphragm 12. Additionally, the pressure sensor 1 is supported on the inside wall of a housing 17, through a cover plate 15 made from sapphire, and a metal plate 16, made from a corrosion-resistant metal material, illustrated by the dotted lines in the figure. Note that in FIG. 1 there is no hatching of the cross-sectional surfaces of any of these structural elements, for ease in explanation.

A through hole 11b, for maintaining the interior of the capacitance chamber in a vacuum, is formed in the base portion 11, where the pressure within the capacitance chamber is maintained at a vacuum through a gas-absorbing substance known as a getter (not shown) provided on the chamber 17a side of the housing 17.

A recessed portion 11a is formed in the base portion 11 through dry etching, and a pressure sensitive capacitance detecting electrode 111, which is, for example, circular in the plan view, is made from gold (Au) or platinum (Pt) in essentially the center portion of the recessed portion 11a. Additionally, a reference capacitance detecting electrode 112, which is, for example, ring-shaped in the plan view, is formed separately from the pressure sensitive capacitance detecting electrode 111, so as to encompass the pressure sensitive capacitance detecting electrode 111.

On the other hand, not only is a pressure sensitive capacitance detecting electrode 121 of the diaphragm 12 formed at a position facing the pressure sensitive capacitance detecting electrode 111 of the base portion 11 formed on the surface of the capacitance chamber side of the diaphragm 12 as well, but a reference capacitance detecting electrode 122 of the diaphragm 12 is also formed at a position facing the reference capacitance detecting electrode 112 of the base portion 11.

Furthermore, the individual electrodes 111, 112, 121, and 122 of the diaphragm 12 and the base portion 11 are each connected electrically to the outside of the sensor through lead lines (illustrated in representation by only the lead lines 131 and 132 in FIG. 1) and electrode pads (illustrated in representation by only the electrode pads 141 and 142 in FIG. 1).

Furthermore, the pressure sensor 1 is partitioned, by a pressure partitioning wall made from the aforementioned cover plate 15 and metal plate 16 into a reference pressure region that is a vacuum within the capacitance chamber formed by the chamber 17a of the housing 17 that is made from, for example, stainless steel (SUS) or \INCONEL®, which is the outside portion of the base, and a pressure application region 17b of the outside portion of the diaphragm to which the pressure of the gas to be measured is applied. Note that the diaphragm 12 is not seated in the range of use requiring accurate measurements measurement accuracy in the pressure sensor 1.

As described above, the pressure sensitive capacitance detecting portion 101, made from the pressure sensitive capacitance detecting electrodes 111 and 121 is formed in a region of high sensitivity to the pressure of the diaphragm 12, forming a capacitor facing the circular electrode, and having a pressure sensitive capacitance CX. In addition, the reference capacitance detecting portion 102, made from the reference capacitance detecting electrodes 112 and 122, is formed in a region with low pressure sensitivity to the pressure on the diaphragm 12, outside of the pressure sensitive capacitance detecting portion 101, forming a capacitor facing the ring-shaped electrode, having a reference capacitance CY.

Note that while the electrostatic capacitance between the electrodes of the pressure sensor will vary depending on, for example, deformation of the diaphragm 12 due to variability in the ambient temperature in the pressure sensor 1, two capacitors are formed in the single pressure sensor in this way, making it possible to cancel out the difference in the output due to variations in temperature in measurements of extremely small pressures requiring high measurement accuracies through performing the pressure measurements using both the reference capacitance detecting portion 102 and the pressure sensitive capacitance detecting portion 101 while performing special signal processing.

The absolute pressure-type pressure sensor 1, structured in this way, is disposed, while maintaining a small space, within a vacuum chamber in, for example, an ordinary semiconductor chip manufacturing process, to not only measure the pressure of the semiconductor processing gases when the vacuum chamber is in a closed state, or in other words, to not only measure the pressure in the near-vacuum domain, but to also measure whether or not the inside of the chamber is at a gauge pressure that is appropriate for handling, such as when the process chamber is opened and the silicon wafers are inserted into the chamber or the silicon chips are removed.

The method for measuring the pressure by performing temperature compensation based on the outputs from the pressure sensitive capacitance detecting portion 101 and the reference capacitance detecting portion 102 will be explained next.

The absolute pressure-type pressure sensor 1 as set forth in the first example of embodiment is a pressure sensor for detecting, as a change in capacitance, the change in the gap between the electrodes due to pressure, as described above. Furthermore, as described above, the pressure sensitive capacitance detecting portion 101, wherein there are changes due to the pressure, is disposed in the center region of the diaphragm. Note that the pressure sensitive capacitance CX also has error characteristics caused by thermal expansion of each of the electrodes due to variability in temperature. Because of this, a reference capacitance detecting portion 102, wherein there is no change due to pressure, is disposed in the peripheral region of the diaphragm in order to correct for the error described above.

Here the respective capacitance values are given by the formulas below, with the amount of change in the distance d between the electrodes of the pressure sensitive capacitance detecting portion 101, which changes due to the pressure that is applied to the diaphragm 12, defined as Δd.

$$\begin{matrix}CX = ɛ \cdot \frac{S}{d - Δ d} & [ Equation 1 ] \\ CY = ɛ \cdot \frac{S}{d} & [ Equation 2 ]\end{matrix}$$

ε: Electric Permittivity

d: Distance between electrodes

S: Surface area of electrodes

By performing the measurements described below, the effect of deformation of the diaphragm, etc., due to variations in temperature is canceled, enabling robust measurements of the absolute pressure that is proportional to the change in the distance between electrodes, or in other words, proportional to the change in pressure when these influences have been canceled out.

$$\frac{CX - CY}{CX} = \frac{ɛ \cdot \frac{S}{d - Δ d} - ɛ \cdot \frac{S}{d}}{ɛ \cdot \frac{S}{d - Δ d}} = \frac{Δ d}{d} \qquad [ Equation 3 ]$$

Note that while the capacitance-type pressure sensor as set forth in the first example of embodiment was explained above as an absolute pressure-type pressure sensor, it can, of course, be applied also to a gauge pressure-type capacitance-type pressure sensor with the inside of the chamber 17a at atmospheric pressure.

A differential pressure-type capacitance-type pressure sensor 2 as set forth in another embodiment according to the present invention will be described next. Note that the materials for each of these structural elements of the capacitance-type pressure sensor 2 are identical to those in the capacitance-type pressure sensor as set forth above.

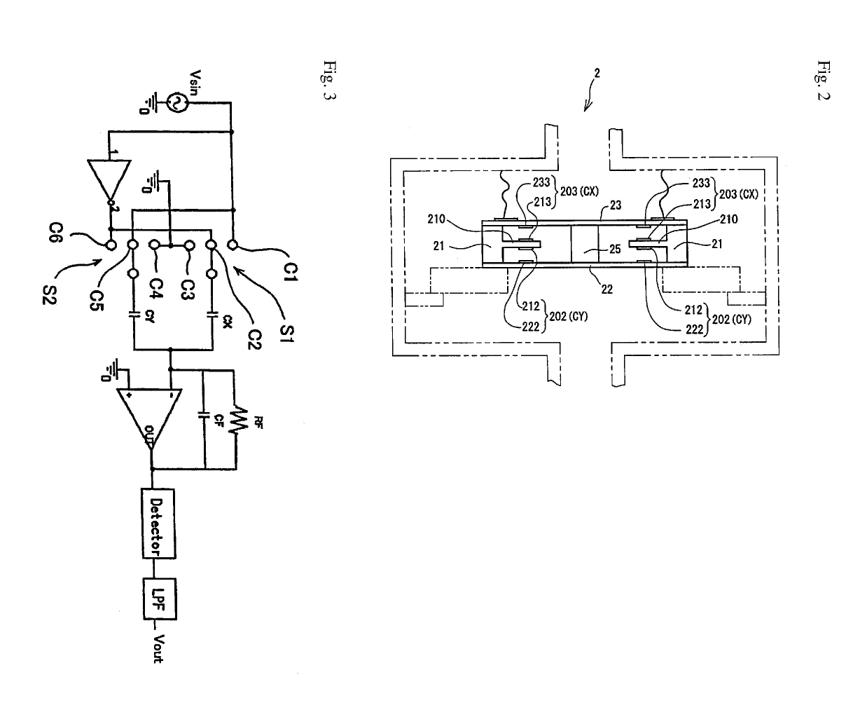

The differential pressure-type capacitance-type pressure sensor 2 according to the present invention, as illustrated in FIG. 2, is provided with a base portion 21, formed in the shape of a thick ring, wherein is formed a protruding portion 210 that faces towards the inside around the entire periphery at essentially the center portion of the inner peripheral surface, diaphragms 22 and 23 that are formed so as to cover both opening portions of the ring-shaped base portion 21, having the center portions thereof connected together through a connecting portion 25, first electrodes 213 and 233 that are each formed facing each other on the protruding portion 210 of the base portion 21 and on one of the diaphragms 23, and second electrodes 212 and 222 that are each formed facing each other on the protruding portion 210 of the base portion 21 and on the other diaphragm 22.

When different pressures are applied to the one diaphragm 23 and the other diaphragm 22, and the pressure that is applied to the one diaphragm 23 is less than the pressure that is applied to the other diaphragm 22, the one diaphragm 23 and the other diaphragm 22 shift, essentially in parallel, upwards in the diagram due to the connecting portion 25. As a result, the gap between the second electrodes 212 and 222 is narrowed, and the gap between the first electrodes 213 and 233 is widened. The result is that there will be different changes in the first electrode gap capacitance CX (203) corresponding to the gap between the first electrodes 213 and 233 and the second electrode gap capacitance CY (202) corresponding to the gap between the second electrodes 212 and 213.

When different pressures are applied to the one diaphragm 23 and the other diaphragm 22, and the pressure that is applied to the other diaphragm 22 is greater than the pressure that is applied to the one diaphragm 23, then the one diaphragm 23 and the other diaphragm 22 shift, essentially in parallel, downward in the figure due to the connecting portion 25. As a result, the gap between the first electrodes 213 and 233 is narrowed and the gap between the second electrodes 212 and 222 is widened, with the result that there will be different changes in the first electrode gap capacitance CX corresponding to the first electrodes 213 and 233 and the second electrode gap capacitance CY corresponding to the gap between the second electrodes 212 and 222.

In this differential pressure-type capacitance-type pressure sensor 2, the first electrode gap capacitance CX and the second electrode gap capacitance CY are given by the formulas below, with the amount of change in the distance between each of the electrodes when, for example, each has been moved downward by the differential pressure between the diaphragms 22 and 23 illustrated in FIG. 2 is defined as Δd:

$$\begin{matrix}CX = ɛ \cdot \frac{S}{d - Δ d} & [ Equation 4 ] \\ CY = ɛ \cdot \frac{S}{d + Δ d} & [ Equation 5 ]\end{matrix}$$

ε: Electric Permittivity

d: Distance between electrodes

S: Surface area of electrodes

Moreover, performing the measurement described below enables the robust measurements of differential pressure, proportional to the change in distances between the electrodes, or in other words, proportional to the change in pressure, in a state wherein the effects of the deformation in the diaphragms, etc. due to variability in temperature has been canceled out.

$$\frac{CX - CY}{CX + CY} = \frac{ɛ \cdot \frac{S}{d - Δ d} - ɛ \cdot \frac{S}{d + Δ d}}{ɛ \cdot \frac{S}{d - Δ d} + ɛ \cdot \frac{S}{d + Δ d}} = \frac{Δ d}{d} \qquad [ Equation 6 ]$$

The structure of the pressure detecting circuit that provides the capacitance-type pressure sensor disconnect detecting function in the first and second examples of embodiment, set forth above, will be explained next.

This pressure detecting circuit comprises a first pressure detecting circuit and a second pressure detecting circuit, used in common in both of the examples of embodiment set forth above. The first pressure detecting circuit will be explained first.

The first pressure detecting circuit has a structure such as illustrated in FIG. 3. Here Vsin indicates the signal (alternating current) that is inputted into this circuit; CX indicates the capacitance corresponding to the pressure sensitive capacitance detecting portion 101 of the capacitance-type pressure sensor 1 for the absolute pressure (or gauge pressure), or corresponding to the first electrode gap capacitance detecting portion 203 of the differential capacitance-type pressure sensor 2 in the second example of embodiment; and CY indicates the capacitance corresponding to the pressure sensitive capacitance detecting portion 102 of the capacitance-type pressure sensor 1 for the absolute pressure (or gauge pressure) in the first example of embodiment, or corresponding to the second electrode gap capacitance detecting portion 202 of the differential capacitance-type pressure sensor 2 in the second example of embodiment. Furthermore, CF indicates the capacitance in the circuit; RF is the resistance value in the circuit; and Detector indicates a half-wave rectifying circuit or a full-wave rectifying circuit. Furthermore, LPF is a low pass filter that smoothes the rectified current.

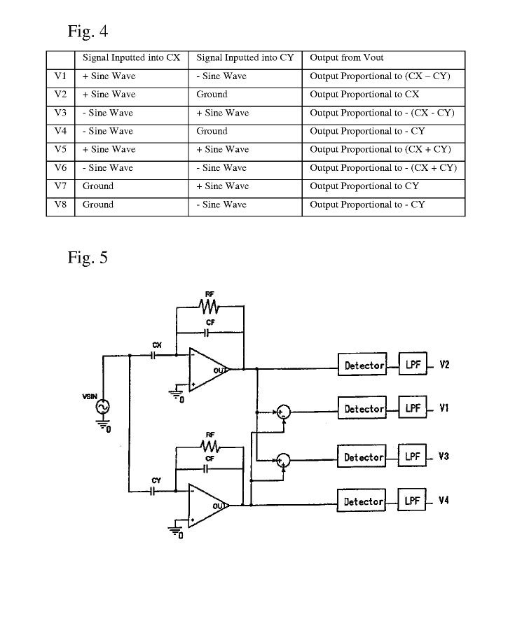

Additionally, by not only applying the specific alternating current Vsin, but also appropriately switching the contact points of the detecting circuit switches S1 and S2 to C1 through C3 and C4 through C6, it is possible to obtain output signals that differ through time division, as illustrated by V1 through V8 in FIG. 4.

Specifically, the contact points of the switch S1 are the C1 through C3 terminals, and the contact points of the switch S2 are the C4 through C6 terminals. The C3 and C4 terminals of the switch S1 and the switch S2 are always maintained at the zero potential voltage level. The capacitance CX is connected to the switch St, and three different voltages are selected and applied to the capacitance CX depending on the position of the switch S1. Similarly, the capacitance CY is connected to the switch S2, and three different voltages are selected and applied to the capacitance CY depending on the position of the switch S2. This makes it possible to selectively apply, to the capacitance CX, the zero potential voltage or the positive or inverted alternating current voltages depending on the switch S2. The same is true for the capacitance CY, where it is possible to selectively apply the zero potential voltage or the positive or inverted alternating current voltage2 depending on the switch S2. Additionally, the output of the capacitance detecting portion is applied to the amplifier on the right-hand side in the figure, to be amplified. The amplified alternating current signal is converted to a direct current detection signal by the Detector and the LPF, to become the output signal Vout.

As described above, switching the alternating current indicated by Vsin using the switches S1 and S2 causes time division of the input signal into the capacitance CX and of a different input signal into the capacitance CY, forming a sine wave voltage wherein the current is converted into a voltage after passing through the CF in the circuit. The alternating current voltage is converted into a direct current voltage through full wave rectification or half wave rectification by the Detector, and this voltage is smoothed by the LPF. Furthermore, the signal output values V1 through V8 are obtained based on the individual capacitances CX and CY through this signal processing.

That is, in the case of the detecting circuit illustrated in FIG. 3, signals are outputted proportional to CX−CY, CX, −(CX−CY), −CX, (CX+CY), −(CX+CY), CY, and −CY, respectively, from the structure of the circuit, at the signal output values V1 through V8, and can be used as reliable pressure measurement values when measuring absolute pressure or atmospheric pressure.

Additionally, in the case of the capacitance-type pressure sensor 1 of the absolute pressure type or the gauge type, as set forth in the first example of embodiment, Δd/d, corresponding to the pressure to be measured, can be calculated through the calculation set forth below.

Note that even though, strictly speaking, the individual items in the equations below have mutually proportional relationships, for ease in explanation they are illustrated as equality expressions.

$$\frac{V 1}{V 2} = \frac{CX - CY}{CX} = \frac{Δ d}{d} \qquad [ Equation 7 ]$$

Conversely, in order to further eliminate error factors in the circuits, the calculation is performed as shown below, making it possible to calculate Δd/d, corresponding to the pressure to be measured, with greater accuracy.

$$\frac{V 1 - V 3}{V 2 - V 4} = \frac{2 ( CX - CY )}{2 CX} = \frac{Δ d}{d} \qquad [ Equation 8 ]$$

On the other hand, in the case of the differential pressure-type capacitance-type pressure sensor as set forth in the second example of embodiment, the Δd/d corresponding to the differential pressure to be measured can be calculated as set forth below.

$$\frac{V 1}{V 5} = \frac{CX - CY}{CX + CY} = \frac{Δ d}{d} \qquad [ Equation 9 ]$$

Conversely, in order to further eliminate error factors in the circuits, the calculation is performed as shown below, making it possible to calculate Δd/d, corresponding to the pressure to be measured, with greater accuracy.

$$\frac{V 1 - V 3}{V 5 - V 6} = \frac{2 ( CX - CY )}{2 ( CX + CY )} = \frac{Δ d}{d} \qquad [ Equation 10 ]$$

The second pressure detecting circuit will be described next. The second pressure detecting circuit has the circuit structure illustrated in FIG. 5. This second pressure detecting circuit has four output ports corresponding to V1 through V4, and rather than obtaining different output values through time division as in the first pressure detecting circuit illustrated in FIG. 3, each of the output ports V1, V2, V3, and V4 simultaneously output the individual signals that are proportional to CX−CY, CX, CX+CY, and CY, respectively.

Specifically, the capacitance CX and CY signals are each amplified by the amplifiers at the top and bottom of FIG. 5. The amplified capacitance CX signal is detected and rectified as-is by the Detector and the LPF, to become the V2 output, where, after subtraction, by a subtracter, from the amplified capacitance CY, this becomes the V1 signal that has been detected and rectified by the Detector and the LPF. Furthermore, after addition of the amplified capacitance CY output by an adder, this becomes the V3 signal that is detected and rectified by the Detector and the LPF. In addition, the signal that is outputted from the capacitance CY is detected and rectified as-is by the gap detector and the LPF to become the V4 signal.

In addition, in the case of the absolute pressure-type or gauge pressure-type capacitance-type pressure sensor as set forth in the first example of embodiment, calculations are performed as shown below to make it possible to obtain Δd/d corresponding to the pressure to be measured.

$$\frac{V 1}{V 2} = \frac{CX - CY}{CX} = \frac{Δ d}{d} \qquad [ Equation 11 ]$$

In addition, in the case of the differential pressure-type capacitance-type pressure sensor as set forth in the second example of embodiment, Δd/d corresponding to the pressure to be measured can be calculated through calculations such as shown below.

$$\frac{V 1}{V 2} = \frac{CX - CY}{CX + CY} = \frac{Δ d}{d} \qquad [ Equation 12 ]$$

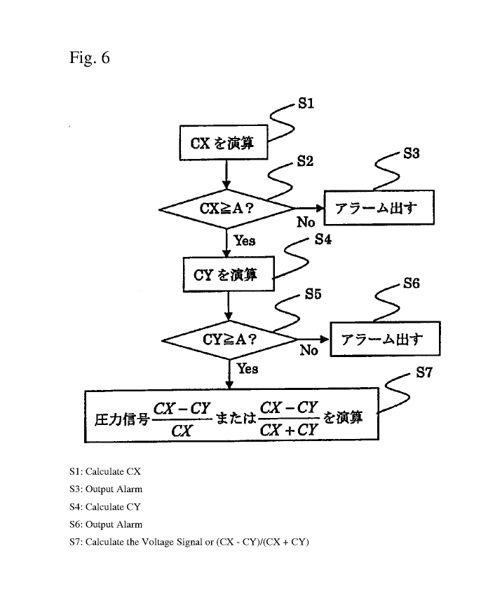

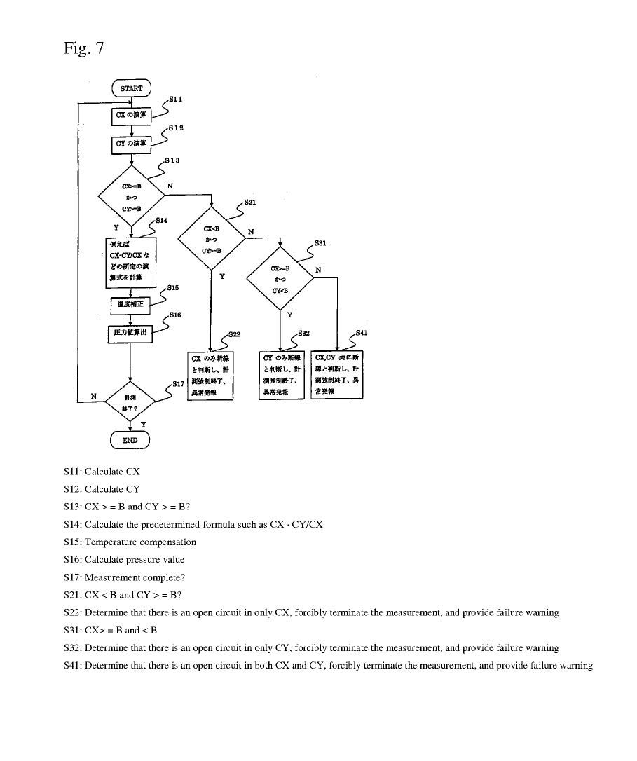

The disconnect detecting algorithms for the pressure sensors as set forth in the examples of embodiment, using the signal output values obtained from the circuit structure set forth above, will be explained next based on FIG. 6 and FIG. 7.

Note that the disconnect detecting algorithms described below may be applied to both the absolute pressure (and gauge pressure)-type capacitance-type pressure sensor set forth in the first example of embodiment, described above, and to the differential pressure-type capacitance-type pressure sensor set forth in the second example of embodiment.

In addition, the capacitance CX, shown below, indicates the pressure sensitive capacitance CX in the first example of embodiment, and indicates the first electrode gap capacitance CX in the second example of embodiment. Similarly, the capacitance CY indicates the reference capacitance CY in the first example of embodiment, and indicates the second electrode gap capacitance CY in the second example of embodiment.

The specific detail of the first on result in this disconnect detection is as described below. In this disconnect detecting routine, in the case of the first detecting circuit illustrated in FIG. 3, assessments are made as to whether or not the capacitances CX and CY exceed their respective predetermined threshold values A, based on the output signal V2, which is proportional to the capacitance CX, and the output signal B7, which is proportional to the capacitance CY, of the V1 through V8 signal outputs illustrated in FIG. 4, obtained through time division through the switching of the switch S1 and the switch S2, and if these values exceed the predetermined threshold values A, then the aforementioned (CX−CY)/CX or (CX−CY)/(CX+CY) is calculated.

That is, the disconnect detection for the pressure sensitive capacitance detecting portion 101 and the disconnect detection for the reference capacitance detecting portion 102 are performed simultaneously when the output signals are obtained, through time division, as illustrated in FIG. 4, by switching the switch S1 and the switch S2, illustrated in FIG. 3, appropriately.

On the other hand, in the case wherein the second detection circuit, illustrated in FIG. 5, is used, of the output signals V1 through V4 in FIG. 5, the output signal V2, which is proportional to the capacitance CX, and the output signal V4, which is proportional to the capacitance CY, are used.

Specifically, the capacitance CX is calculated first (step S1). Then an assessment is performed as to whether or not this capacitance CX is greater than the threshold value A, which is the minimum value for the output value that is outputted in the normal operating range of the pressure sensor or differential pressure sensor (step S2), and if less than this threshold value A, then an disconnect detection alarm is outputted (step S3). Additionally, if it is determined that the result is greater than the threshold value A (step S4), then the capacitance CY is measured (step S5). If the capacitance CY is less than the threshold value A which is the minimum value of the output value that is outputted in the normal operating range of the pressure sensor, then an disconnect detection alarm is outputted (step S6).

In this way, if either of the capacitances CX or CY is less than the predetermined threshold value A, then it is determined that there is an disconnect in an interconnection line in the capacitance CX detecting portion and/or the capacitance CY detecting portion, producing an alarm.

If either of the capacitances CX or CY is less than the predetermined threshold value A (step S5), then, in the case of the absolute pressure or gauge pressure-type pressure sensor in the first example of embodiment, (CX−CY)/CX is calculated, and in the case of the differential pressure-type pressure sensor in the second example of embodiment, (CX−CY)/(CX+CY) is calculated, to output Δd/d, which accurately indicates the absolute pressure or gauge pressure, or the differential pressure (step S7).

A second algorithm, which is a modified form of this disconnect detecting routine, will be explained next based on FIG. 7. This disconnect detecting routine adds, to the disconnect detecting routine functions illustrated in FIG. 6, a function able to specify whether an disconnect has occurred in only the interconnection pertaining to the pressure sensitive capacitance detecting portion 101 in one embodiment (or an disconnect in the interconnection pertaining to the first electrode gap capacitance detecting portion in another embodiment), an disconnect has occurred in only the interconnection pertaining to the reference capacitance detecting portion 102 in one embodiment (or an disconnect has occurred in the interconnection pertaining to the second electrode gap capacitance detecting portion in the other embodiment), or whether disconnects have occurred in the interconnections pertaining to both of the capacitance detecting portions. The disconnect detecting routine for this second algorithm will be described below.

Note that the capacitance CX, indicated below, indicates the pressure sensitive capacitance CX in an embodiment and indicates the first electrode gap capacitance CX in the other embodiment. Similarly, the capacitance CY indicates the reference capacitance CY in the first example of embodiment, and indicates the second electrode gap capacitance CY in the other embodiment.

Of the output signals V1 through V8 of the time division in the first detecting circuit, the capacitance CY is calculated based on the output signal V2 (step S11), and the capacitance CY is calculated based on the output signal V7 (step S12).

Additionally, in the second detecting circuit, the capacitance CX is calculated based on the output signal V2, which is outputted simultaneously (step S11) and the capacitance CY is calculated based on the output signal V 4 (step S12).

Following this, an assessment is performed as to whether or not the capacitance CX is greater than a predetermined threshold value B and the capacitance CY is greater than the predetermined threshold value B (step S13). Note that the predetermined threshold value referred to here is the minimum value for the output value that is outputted in the range of normal operations by the capacitance-type pressure sensor for the signal output values for the individual capacitances CX and CY, as was the case in the first algorithm, described above.

If the conditions in this step S13 are fulfilled, then, in the case of the absolute pressure or gauge pressure-type capacitance-type pressure sensor as set forth in one embodiment, for example, a calculation is performed by a predetermined formula, such as (CX−CY)/CX, and in the case of the differential pressure-type capacitance-type pressure sensor as set forth in the other, the (CX−CY)/(CX+CY) calculation is performed (step S14).

Following this, temperature compensation is performed (step S15), and the pressure value is calculated (step S16). Following this, an assessment is performed as to whether or not the measurement is complete (step S17), where if the measurement has not yet been completed, then the routine in step S11 through step S16 is repeated until the measurement is complete. If the measurement has been completed, then the pressure measurement routine is terminated.

On the other hand, if, in step S13, the capacitance CX and/or the capacitance CY is below the predetermined threshold value B, then it is determined that an disconnect has occurred in an interconnection line in a capacitance detecting portion, and control jumps to the disconnect detecting routine. First and assessment is made as to whether or not the capacitance CX is below the predetermined threshold value B and the capacitance CY is above the predetermined threshold value B (step S21). If the conditions of step S21 are fulfilled, then it is determined that there is an disconnect in the interconnection pertaining to only the capacitance CX, and the pressure (differential pressure) measurement is forcibly terminated, and a failure alarm is produced for an interconnection disconnect for the capacitance CX (step S22).

If the conditions in step S21 are not fulfilled, then an assessment is made as to whether or not the capacitance CX exceeds the predetermined threshold value B and the capacitance CY is lower than the predetermined threshold value B (step S31).

If the conditions in step S31 are fulfilled, then it is determined that there is an disconnect in the interconnection pertaining to only the capacitance CY, the pressure (differential pressure) measurement is forcibly terminated, and a failure alarm for an interconnection disconnect is produced for the capacitance CY (step S32).

If the conditions of step S31 are not fulfilled, then it is determined that there are disconnects for the interconnections relating to both the capacitance CX and the capacitance CY, the pressure (differential pressure) measurement is forcibly terminated, and failure alarms are issued for the interconnection disconnects for both the capacitance CX and the capacitance CY (step S41).

Given the above, it is possible to perform individual discrimination as to whether the disconnect is in an interconnection pertaining to only the capacitance CX, whether the disconnect is in an interconnection pertaining to only the capacitance CY, or whether there are disconnects in interconnections pertaining to both the capacitance CX and the capacitance CY, thus making it possible to perform the disconnect detection in detail.

Finally, an explanation will be given by comparing the different effects in operation when performing the disconnect detecting algorithm described above for the capacitance-type pressure sensors at as set forth in the individual examples of embodiment according to the present invention when compared to the disconnect detection in the conventional acceleration sensor.

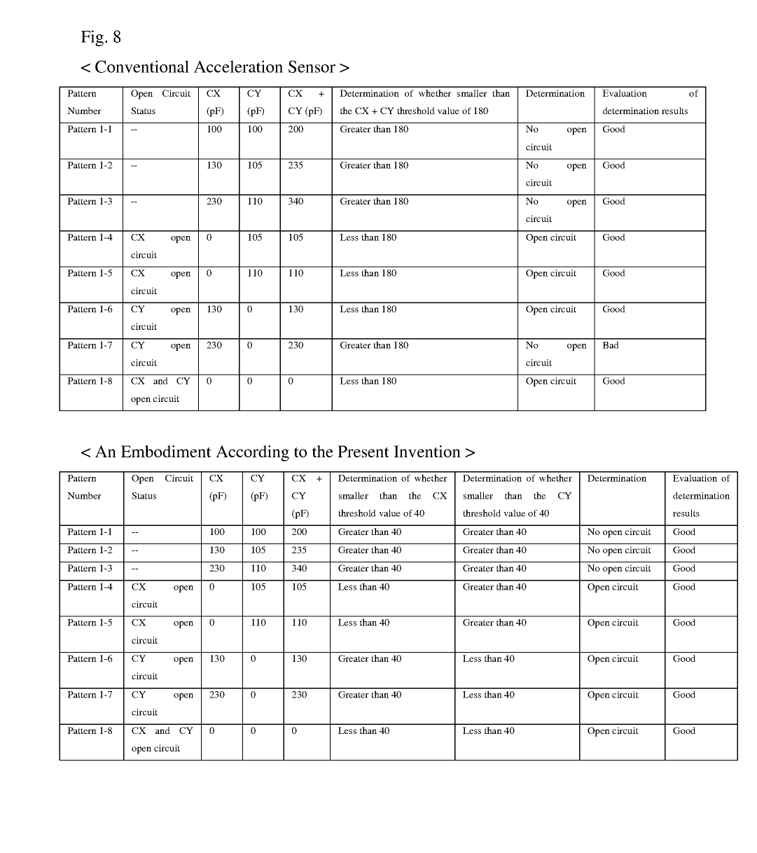

The table at the top of FIG. 8 is a table that explains the disconnect detection of the conventional acceleration sensor, and the table at the bottom of FIG. 8 is a table that explains the disconnect detection in an embodiment according to the present invention (in the case of an absolute pressure-type sensor, wherein CX has become large and CY has not increased or has increased only slightly).

In the disconnect detecting method in the conventional acceleration sensor, when, as illustrated in the top table in FIG. 8, the sum of the capacitance CX and the capacitance CY between the movable electrode and the stationary electrodes for the disconnect detection has a threshold value that is set to 180 pF, if the capacitance CX is 100 pF and the capacitance CY is 100 pF, then the capacitance CX+capacitance CY=200 pF, which exceeds the threshold value of 180 pF that has been set, so the determination is that there is no disconnect. (See pattern 1-1.)

However, if one of the capacitances CX is 230 pF, exceeding the 180 pF that is the threshold value that is set for the capacitance CX+capacitance CY, then if there is an disconnect in the interconnections relating to the other capacitance CY, then CX+CY=230 pF+0 pF=230 pF, and despite the disconnect in the interconnection line pertaining to the capacitance CY, the determination would be that of a normal range, and the acceleration measurement would be performed as normal. (See pattern 1-7.)

In this case of the conventional acceleration sensor, the determination that there is an disconnect failure is only made when there is a deviation from the specification value for the sum of the capacitance CX and the capacitance CY between the respective electrodes, so that when there is an disconnect pertaining to one of the other interconnections when the capacitance of, for example, either the capacitance CX or the capacitance CY exceeds the specification value, then it may not be possible to detect the occurrence of the disconnect, notwithstanding the occurrence of an disconnect in the interconnection pertaining to one of the capacitances.

On the other hand, for the absolute pressure-type capacitance-type pressure sensor as set forth in the present invention, within the algorithm for the disconnect detecting method set forth above is executed, then, as illustrated in the bottom table in FIG. 8, if the threshold value for the capacitance CX is set to 40 pF and the threshold value for the capacitance CY is set to 40 pF, then if, for example, the capacitance CX is 100 pF and the capacitance CY is 100 pF, then the capacitance CX and the capacitance CY would exceed their individual threshold values, and the pressure (CX−CY)/CX would be measured, with no occurrence of an disconnect. (See pattern 1-1.)

Additionally, if the capacitance CY is at 0 pF (as an disconnect), and the capacitance CY is at 105 pF, then the capacitance CY exceeds the threshold value, but because the capacitance CX is less than the threshold value, it is possible to determine that there is an disconnect in the interconnection pertaining to one of the capacitances, using the first capacitance detecting algorithm, and using the second capacitance detecting algorithm, it is possible to determine that the disconnect is in the interconnection pertaining to the capacitance CX. (See pattern 1-4.)

Similarly, if the capacitance CX is at 130 pF and the capacitance CY is at 0 pF (as an disconnect), then the capacitance CX exceeds the threshold value but the capacitance CY is below the threshold value, so it is possible to determine by the first disconnect detecting algorithm that there is an disconnect for an interconnection pertaining to one of the capacitances, and by the second disconnect detecting algorithm, it is possible to determine that there is an disconnect in the interconnection pertaining to the capacitance CY. (See pattern 1-6.)

Additionally, if the capacitance CX is at 230 pF and the capacitance CY is at 0 pF (as an disconnect), then even though the capacitance CX+the capacitance CY is 230 pF, the capacitance CY is less than 40 pF, which is the threshold value, so it can be determined by the first disconnect detecting algorithm that there is an disconnect in an interconnection pertaining to one of the capacitances, and it is possible to determine by the second disconnect detecting algorithm that there is an disconnect in the interconnection pertaining to the capacitance CY. (See pattern 1-7.)

Similarly, a comparison of the differences in the results will be explained for the case of performing the disconnect detecting algorithm described above for the differential pressure-type capacitance-type pressure sensor as set forth in the other example of embodiment according to the present invention, as compared to the disconnect detection in the conventional acceleration sensor.

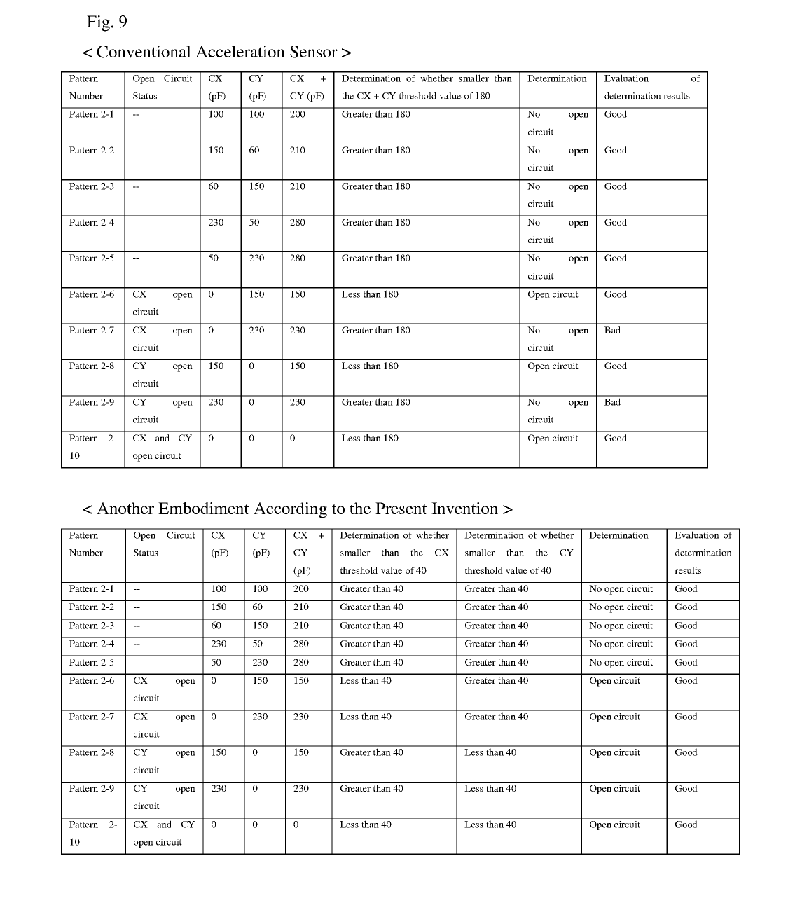

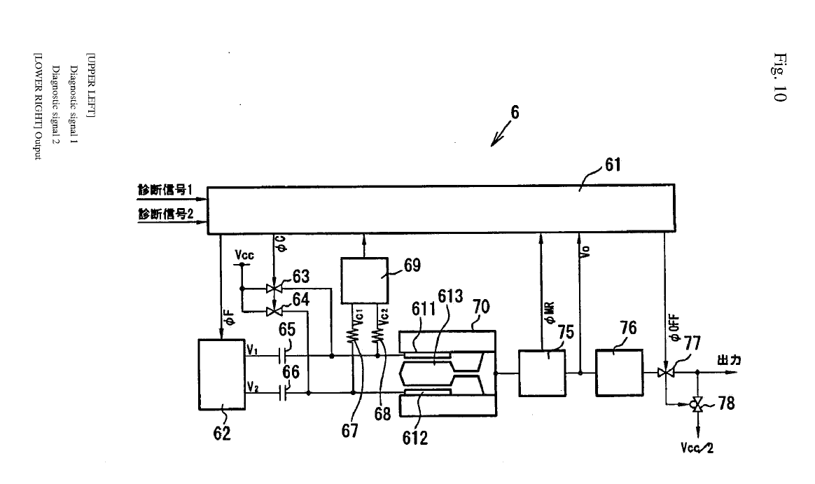

The table at the top of FIG. 9 is a table that explains the disconnect detection in the conventional acceleration sensor, and the table at the bottom of FIG. 9 is a table that explains the disconnect detection in the second example of embodiment according to the present invention (for the case of a differential sensor, wherein the capacitance on one side has increased, and the capacitance on the other side has decreased).

On the other hand, for the absolute pressure-type capacitance-type pressure sensor according to the present invention, within the algorithm for the disconnect detecting method set forth above is executed, then, as illustrated in the bottom table in FIG. 9, if the threshold value for the capacitance CX is set to 40 pF and the threshold value for the capacitance CY is set to 40 pF, then if, for example, the capacitance CX is 100 pF and the capacitance CY is 100 pF, then the capacitance CX+the capacitance CY=200 pF, exceeding the threshold value of 180 pF, and so it would be determined that there is no disconnect. (See pattern 2-1.)

However, if one of the capacitances CY is 230 pF, exceeding the 180 pF that is the threshold value that is set for the capacitance CX+capacitance CY, then if there is an disconnect in the interconnections relating to the capacitance CX, then CX+CY=0 pF+230 pF=230 pF, and despite the disconnect in the interconnection line pertaining to the capacitance CX, the determination would be that of a normal range, and the acceleration measurement would be performed as normal. (See pattern 2-7.) This is the same as if, for example, the other capacitance CX=230 pF, and the one capacitance CY is at 0 pF (as an disconnect), so that the sum of the capacitances CX and CY exceeds the threshold value of 180 pF. (See pattern 2-9.)

That is, as can be understood from the pattern 2 illustrated at the top of FIG. 9, in the case of the conventional acceleration sensor, an disconnect failure is only identified when the sum of the capacitance CX and the capacitance CY between the electrodes deviates from the specification value, and so in the case wherein, for example, the capacitance for either the capacitance CX or the capacitance CY exceeds the specification value and there is an disconnect in an interconnection pertaining to the other capacitance, it may not be possible to detect the occurrence of the disconnect regardless of there being an disconnect in the interconnection pertaining to the first capacitance.

On the other hand, when the algorithm for the disconnect detecting method set forth above is executed in the differential capacitance-type pressure sensor as set forth in the other embodiment according to the present invention, then, as illustrated in the bottom table in FIG. 9, when the threshold value of the capacitance CX is set to 40 pF and the threshold value for the capacitance CY is set to 40 pF, then if, for example, the capacitance CX is 100 pF and the capacitance CY is 100 pF, then the capacitance CX and the capacitance CY both exceed the respective threshold values, so the pressure is calculated for (CX−CY)/CX, without the occurrence of an disconnect. (See pattern 2-1.)

Additionally, if the capacitance CY is at 230 pF and the capacitance CX is at 0 pF (as an disconnect), then even though the capacitance CX+CY is 230 pF, the output value for the capacitance CX is below the 40 pF that is the threshold value, so the first disconnect detecting algorithm is able to determine that there is an disconnect in an interconnection pertaining to one of the capacitances, and the second disconnect detecting algorithm is able to determine that there is an disconnect in the interconnection pertaining to the capacitance CX. (See pattern 2-7.)

Furthermore, it is also possible to detect the disconnect in the same manner in the case wherein the capacitance CY is at 0 pF (as an disconnect) and the capacitance CX is at 230 pF. (See pattern 2-9.)

In this way, it is possible to determine, prior to performing the measurement of (CX−CY)/CX, such as in the absolute pressure-type (gauge pressure-type) capacitance-type pressure sensor as set forth in the first example of embodiment, or (CX−CY)/(CX+CY) as in the differential pressure-type capacitance-type pressure sensor as set forth in the other embodiment, to use the first algorithm for disconnect detection as set forth in the present invention to always perform a measurement of each independent signal output value from the capacitance CX and the capacitance CY, to provide a threshold value for the signal output value from the capacitance CX and a threshold value for the signal output value for the capacitance CY, and to determine that there is an disconnect if either of the independent signal output values for the capacitance CX and the capacitance CY falls below the predetermined threshold value, to thereby use an alarm to provide notification regarding the occurrence of the disconnect.

Additionally, it is possible to determine, prior to performing the measurement of (CX−CY)/CX, such as in the absolute pressure-type (gauge pressure-type) capacitance-type pressure sensor as set forth in one embodiment, or (CX−CY)/(CX+CY) as in the differential pressure-type capacitance-type pressure sensor as set forth in the other embodiment, to use the second algorithm for disconnect detection as set forth in the present invention to perform a measurement of each independent signal output value from the capacitance CX and the capacitance CY, to provide a threshold value for the signal output value from the capacitance CX and a threshold value for the signal output value for the capacitance CY, and to determine that there is an disconnect if either of the independent signal output values for the capacitance CX and the capacitance CY falls below the predetermined threshold value, to thereby use an alarm to provide notification regarding the occurrence of the disconnect. This not only makes it possible to determine quickly the cause of the disconnect, but also makes it possible to force a determination of the measurement, making it possible to perform pressure measurements with superior disconnect detection and superior reliability.

Note that instead of calculating the absolute pressure or gauge pressure as (CX−CY)/CX, as in the aforementioned absolute pressure-type capacitance-type pressure sensor, or calculating the differential pressure as (CX−CY)/(CX+CY) as in the differential pressure-type capacitance-type pressure sensor, a circuit structure such as measures (CX−CY)/CY, or CX−CY, or CX/CY, as appropriate depending on the type of pressure or differential pressure sought, can also cancel out the changes in capacitance due to the effects of the temperature characteristics of the diaphragm, making it possible to perform robust measurements of the absolute pressure or gauge pressure, or differential pressure.

Additionally, the materials for structuring the capacitance-type pressure sensor, described above, are not limited to sapphire, but, of course, there is no difference if the material were a semiconductor such as silicon.

In regards to the materials for the other structural elements as well, there is no limitation to the materials in the examples of embodiment described above.

Note that the algorithms set forth above are given as examples, and there is no limitation to the algorithms described above, insofar as the algorithm is included within the scope of the present invention.

1: A method for measuring changes in the physical volume of a medium that is measured, comprising the steps of:
measuring two capacitances wherein the relative relationships between the capacitances will vary in accordance with the change of the physical volume of the medium to be measured, wherein the measuring step comprises the step of:
measuring each individual capacitance values independently, and
determining that there is an disconnect fault when at least one of the individual capacitance values is less than a capacitance value indicated by a normal operating range for the capacitance-type pressure sensor.

2: The method set forth in claim 1, wherein:
one of the two capacitances is a pressure sensitive capacitance, and the other is a reference capacitance.

3: The capacitance-type pressure sensor set forth in claim 1, wherein:
the two capacitances output differently from each other in accordance with a change in the physical volume of the medium to be measured.

4-5. (canceled)
